(19) United States
(12) Patent Application Publication
(10) Pub. No.: US 2006/0034479 A1
(43) Pub. Date: Feb. 16, 2006

(54) Speaker device

(76) Inventors: Kazuhiro Oshika, Matsusaka-shi (JP); Satoshi Koura, Ichishi-gun (JP)

Correspondence Address: RATNERPRESTIA, P O BOX 980, VALLEY FORGE, PA, 19482-0980, US

(21) Appl. No.: 10/535,569

(22) PCT Filed: Aug. 30, 2004
(86) PCT No.: PCT/JP04/12881

§ 371 Date: May 19, 2005

(30) Foreign Application Priority Data
Aug. 29, 2003 (JP) 2003-306672

(51) Int. Cl. H04R 25/00

(52) U.S. Cl. 381/386; 381/399

(57) ABSTRACT

An elongate loudspeaker apparatus which can be used at a television receiver or the like and easily manufactured is provided. The loudspeaker apparatus of the present invention is formed of an elongate printed circuit board and a plurality of loudspeakers mounted on the printed circuit board, and signal inputting parts are formed at both ends thereof. Using the structure mentioned above, the elongate loudspeaker apparatus can be easily provided by arranging the easy-manufacturing loudspeakers. In addition, the loudspeaker apparatuses disposed at both sides thereof can be coupled with a main-unit-side circuit, so that assembling devices becomes easily.

### TECHNICAL FIELD

The present invention relates to a loudspeaker apparatus mainly disposed at both sides of a television receiver.

### BACKGROUND ART

Recently, a television receiver has been required to be large and thin, and also required to be compact. Therefore, a loudspeaker apparatus disposed at both sides of the television receiver is required to be thin and elongate. This kind of elongate loudspeaker is shown in FIGS. 5A to 5C. FIG. 5A is a plan view of the loudspeaker, FIG. 5B is a sectional view thereof in a major axis direction, and FIG. 5C is a sectional view thereof in a minor axis direction.

According to these drawings, inverted dome shaped diaphragm 1 has a nonaxisymmetric shape having a major axis and a minor axis in a plane structure viewed from a vibration direction. In addition, diaphragm 1 bulges in a reverse direction in which sounds are emitted. Edge 2 is connected with an outer periphery of diaphragm 1 and held by frame 5. Magnetic circuit 10 is installed at a bottom of frame 5, and formed of yoke 8, magnet 7, plate 6 and the like.

Dust net 9 is disposed at a window of frame 5 and prevents dust from entering into magnetic circuit 10. Beltlike (i.e. track shape) voice coil bobbin 3 is formed along an outer periphery of diaphragm 1 in parallel to the vibration direction, and connected with the outer periphery of diaphragm 1. Voice coil (not shown) is wound around a position corresponding to magnetic gap 10a of magnetic circuit 10.

The loudspeakers structured discussed above are disposed at both sides of the television receiver which is not shown here.

Unexamined Japanese Patent Publication H9-200891 is known as a conventional art related to the present invention.

### SUMMARY OF THE INVENTION

A loudspeaker apparatus includes the following elements:
an elongate printed circuit board; and
a plurality of loudspeakers mounted on the printed circuit board and aligned substantially straightly in much the same direction as a longitudinal direction of the elongate printed circuit board, each terminal for inputting a signal of the loudspeakers being electrically coupled with a conductive pattern part of the printed circuit board,
where signal inputting parts for inputting a signal from an outside are formed by leading the conductive pattern part to at least both ends of the printed circuit board in the longitudinal direction or neighborhoods thereof.

### BRIEF DESCRIPTION OF THE DRAWINGS

FIG. 1 is a perspective view showing a loudspeaker apparatus of the present invention.

FIG. 2 is a sectional view of a loudspeaker, which is mounted on a printed circuit board in a minor axis direction and an essential part of the loudspeaker apparatus of the present invention.

FIG. 3 is a circuit diagram of the loudspeaker apparatus of the present invention.

FIG. 4A is another example of a circuit diagram of the loudspeaker apparatus of the present invention.

FIG. 4B is still another example of a circuit diagram of the loudspeaker apparatus of the present invention.

FIG. 4C is yet another example of a circuit diagram of the loudspeaker apparatus of the present invention.

FIG. 4D is further example of a circuit diagram of the loudspeaker apparatus of the present invention.

FIG. 5A is a plan view of a conventional loudspeaker.

FIG. 5B is a sectional view of the conventional loudspeaker in a major axis direction.

FIG. 5C is a sectional view of the conventional loudspeaker in a minor axis direction.

### DETAILED DESCRIPTION OF THE PREFERRED EMBODIMENTS

A conventional loudspeaker is long in a major axis direction, so that it is required to produce track shaped voice coil bobbin 3 without meandering, allow for a margin of magnetic gap 10a because of deformation of voice coil bobbin 3, and prevent magnetic circuit 10 and frame 5 from warping. Therefore, manufacturing of the loudspeaker becomes complicate and high cost.

The present invention is directed to solve the problems discussed above, and aims to provide an elongate and easy-manufacturing loudspeaker apparatus.

The present invention has the following structure to solve the problems pointed out above.

The loudspeaker apparatus of the present invention includes an elongate printed circuit board, and a plurality of loudspeakers mounted on the printed circuit board and aligned substantially straightly in much the same direction as a longitudinal direction of the elongate printed circuit board, where each terminal for inputting a signal of the loudspeakers is electrically coupled with a conductive pattern part of the printed circuit board. In addition, signal inputting parts for inputting a signal from an outside are formed by leading the conductive pattern part to at least both ends of the printed circuit board in the longitudinal direction or neighborhoods thereof.

Using the structure mentioned above, a loudspeaker whose manufacturing is complicate is not needed to be produced, and the elongate loudspeaker apparatus can be easily provided by arranging a plurality of easy-manufacturing loudspeakers. Besides, the signal inputting parts for inputting a signal from an outside are formed at ends of the printed circuit board or neighborhoods thereof. Therefore, when the loudspeaker apparatuses are disposed at both sides of a monitor, a main-unit-side circuit of a television receiver, which is generally disposed at a bottom of a cabinet, and the loudspeaker apparatuses disposed at both sides thereof can be coupled with each other under the loudspeaker apparatuses. As a result, assembling devices becomes easily.

Further, according to the loudspeaker apparatus of the present invention, the signal inputting part discussed above is a terminal directly connected with a connector which is coupled with another printed circuit board (e.g. circuit board of a main device) or another printed circuit. Therefore, efficiency of assembling devices further improves.

Still further, according to the loudspeaker apparatus of the present invention, in the loudspeaker apparatus mentioned above, a plurality of loudspeakers are electrically coupled with one another, so that its synthetic impedance is equalized or approximated to an impedance of one loudspeaker. Therefore, even if a main-device-side amplifier is designed based on one loudspeaker, the loudspeaker apparatus of the present invention can be used. As a result, variation from a popular model to a high grade model of an acoustic apparatus of the main device can be provided by changing only the loudspeaker apparatus.

Yet further, according to the loudspeaker apparatus of the present invention, the loudspeakers of the loudspeaker apparatus discussed above are electrically coupled in series. Therefore, the same effect as that mentioned above can be obtained without increasing a load of a main-device-side amplifier.

Furthermore, according to the loudspeaker apparatus of the present invention, a high cut filter, which restrains an input at high frequencies of at least one terminal-section-side loudspeaker of a plurality of loudspeakers disposed at the loudspeaker apparatus, is coupled with the conductive pattern part of the printed circuit board. Therefore, directivity of loudspeakers at a high reproducing frequency can be restrained, which is generated by aligning a plurality of loudspeakers straightly in an arrangement direction.

As discussed above, according to the loudspeaker apparatus of the present invention, the elongate loudspeaker can be easily manufactured and main device circuit board can be easily coupled.

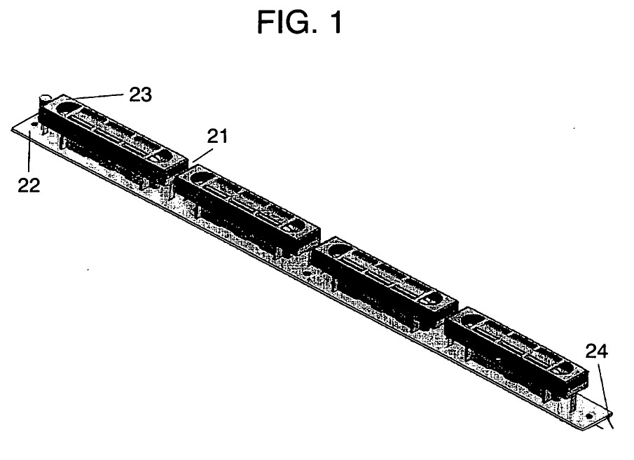

Exemplary embodiments of the loudspeaker apparatus of the present invention are demonstrated hereinafter with reference to FIGS. 1 through 4D.

### First Exemplary Embodiment

The present invention is demonstrated hereinafter with reference to the first embodiment.

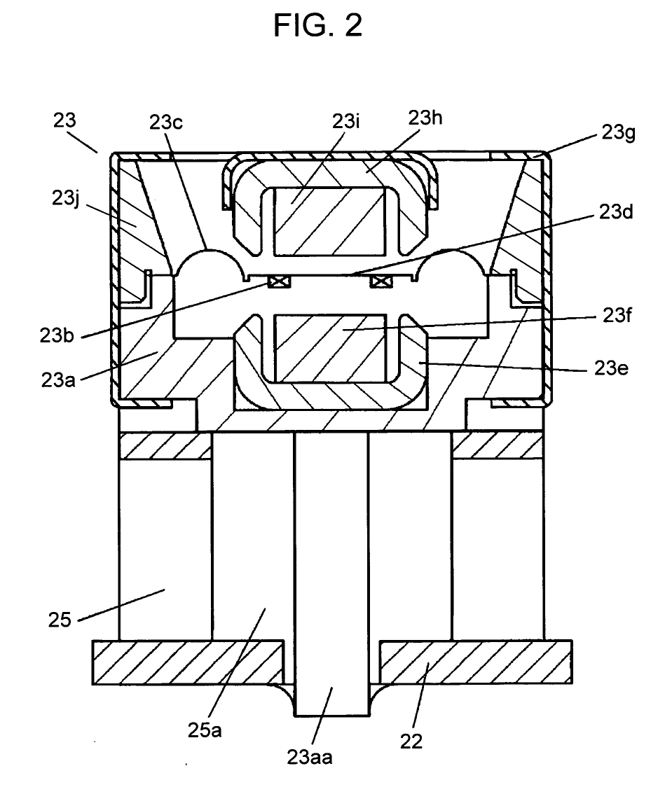

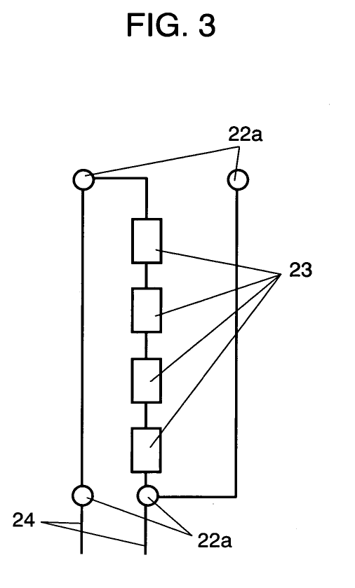

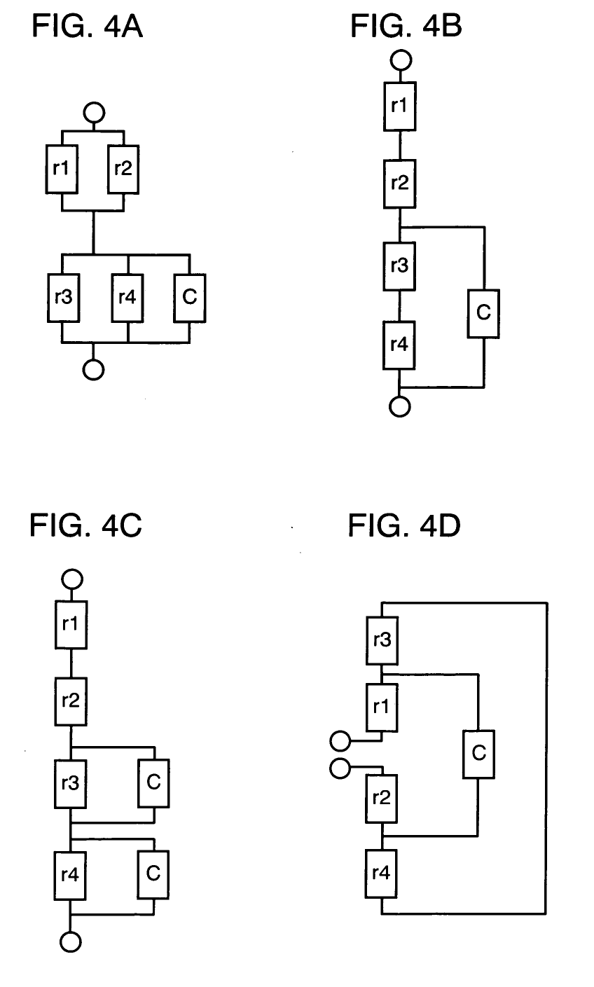

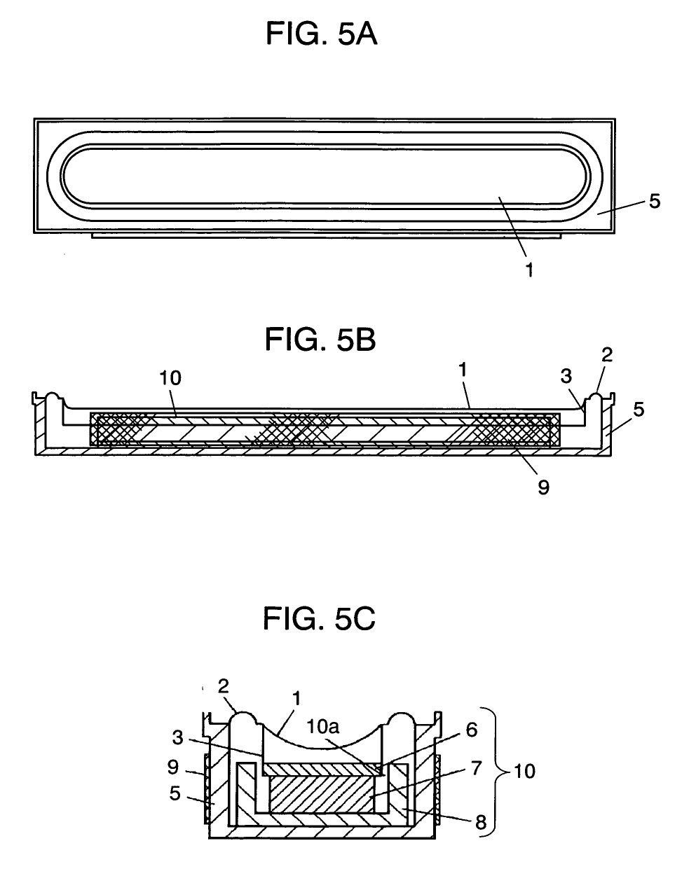

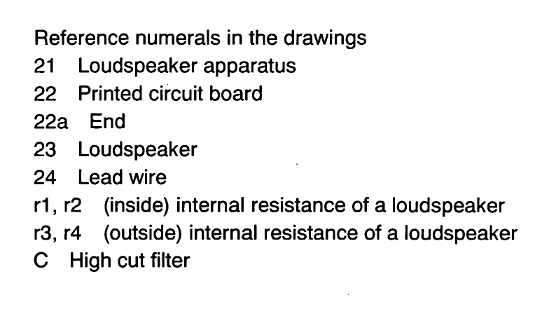

FIG. 1 is a perspective view showing a loudspeaker apparatus of the present invention. FIG. 2 is a sectional view of a loudspeaker, which is mounted on a printed circuit board in a minor axis direction and an essential part of the loudspeaker apparatus of the present invention. FIG. 3 is a circuit diagram of the loudspeaker apparatus of the present invention. FIGS. 4A-4B each is another example of a circuit diagram of the loudspeaker apparatus of the present invention.

In the drawings, reference mark 21 denotes the loudspeaker apparatus, reference mark 22 denotes an elongate printed circuit board having a conductive pattern, and reference marks 23 denote a plurality of loudspeakers. Loudspeakers 23 are aligned substantially straightly on rectangular printed circuit board 22, and coupled electrically and mechanically therewith.

Reference mark 24 denotes a lead wire for inputting an outer sound signal and coupling with a main device (not shown), and one end thereof is coupled with end 22a of the conductive pattern of printed circuit board 22.

A pair of ends 22a is formed at both ends of printed circuit board 22 in the longitudinal direction or neighborhoods thereof, so that lead wire 24 for inputting an outer sound signal can be coupled with either end. Thus, even if the loudspeaker apparatus is disposed at either side of a monitor, the loudspeaker apparatus is easily coupled with the main device. In this case, lead wire 24 may not be formed, and printed circuit board 22 may be directly coupled with the main device or a connector of the main device.

Base 25 is disposed between printed circuit board 22 and loudspeaker 23 above it, and a clearance is formed to dissipate heat. The elongate loudspeaker apparatus is constructed discussed above.

Next, a structure of loudspeaker 23 is described hereinafter. Diaphragm 23d has voice coil 23b, and sandwiched between case 23a and upper case 23j via edge part 23c whose outer periphery is fixed. Case 23a has foot section 23aa and is fixed to printed circuit board 22.

Foot section 23aa may be integrally molded with case 23a with resin. In addition, case 23a may be formed in one piece with a metal plate by insert molding, and can be fixed when loudspeaker 23 is electrically soldered to printed circuit board 22.

A first yoke 23e is bonded on case 23a, and a rectangular first magnet 23f is further bonded thereon. Magnetic cover 23g made of magnetic material such as iron forms a housing with case 23a, and case 23a and upper case 23j sandwich diaphragm 23d mentioned above, so that leakage of a magnetic flux is prevented.

Diaphragm 23d is formed by press-punching a high-heat-resistant resin film (e.g. polyimide resin film) into a certain elongate shape. A conductive wire is formed in a planate elongate spiral shape base on a shape of diaphragm 23d and bonded on diaphragm 23d, so that voice coil 23b is structured. Conventional printing, etching, plating, evaporation or the like can be used as forming voice coil 23b.

A second magnet 23i bonded to a second yoke 23h so as to face a first magnet 23f Loudspeakers 23 are electrically coupled in series, and its synthetic impedance is formed so as to be substantially matched with internal resistance (4 Ω, 8 Ω or 16 Ω) of a general loudspeaker.

By using the structure discussed above, a grade of the loudspeaker apparatus can be changed without changing capacity of an amplifier circuit for a loudspeaker of the main device. In other words, four loudspeakers are used in the present embodiment, however, one loudspeaker or six loudspeakers may be used, so that a popular model to a high grade model having a supreme acoustic characteristic can be provided.

FIGS. 4A-4D each is a circuit diagram of the loudspeaker apparatus. R1 and r2 denote internal resistances of the loudspeakers disposed inside among loudspeakers aligned substantially straightly, and r3 and r4 denote internal resistances of the loudspeakers disposed outside among loudspeakers aligned substantially straightly. “C” denotes a high cut filter for cutting a high frequency of a reproducing frequency. “C” is selected based on a frequency to be cut and a structure of a circuit, and restrains high frequencies of loudspeakers disposed at both outsides of the loudspeaker apparatus. This high cut filter can be realized by coupling a capacitor with a conductive wiring of printed circuit board 22.

When loudspeakers are aligned straightly (even though the loudspeakers are not formed on a printed circuit board), directivity in the straight direction becomes sharp. When the loudspeakers are disposed at both sides of a monitor of a television receiver, directivity in its vertical direction becomes sharp. However, directivity of loudspeaker apparatus 21 is restrained by cutting high frequencies of loudspeakers disposed at both outsides of the loudspeaker apparatus using high cut filter “C”.

In addition, directivity is also restrained by narrowing an interval between loudspeakers 23.

According to the embodiments discussed above, loudspeaker 23 is described as a thin loudspeaker where the voice coil is directly formed at an elongate diagram having a minor axis and a major axis. However, the loudspeaker of the present invention is not limited to the loudspeaker mentioned above, and any loudspeakers which are aligned straightly may be used for forming the loudspeaker apparatus.

### INDUSTRIAL APPLICABILITY

A loudspeaker apparatus of the present invention is formed by aligning a plurality of loudspeakers straightly or substantially straightly on a printed circuit board and can be used in an acoustic apparatus or the like. According to the loudspeaker apparatus of the present invention, the elongate loudspeaker can be easily manufactured and main device circuit board can be easily coupled.

1. A loudspeaker apparatus comprising:
an elongate printed circuit board; and
a plurality of loudspeakers mounted on the printed circuit board and aligned substantially straightly in much the same direction as a longitudinal direction of the elongate printed circuit board, each terminal for inputting a signal of the loudspeakers being electrically coupled with a conductive pattern part of the printed circuit board,
wherein signal inputting parts for inputting a signal from an outside are formed by leading the conductive pattern part to at least both ends of the printed circuit board in the longitudinal direction or neighborhoods thereof.

2. The loudspeaker apparatus of claim 1,
wherein at least one of the signal inputting parts is a terminal directly connected with a connector which is coupled with another printed circuit board or a printed board.

3. The loudspeaker apparatus of claim 1,
wherein the loudspeakers are electrically coupled with one another, and its impedance is equalized or approximated to an impedance of one loudspeaker.

4. The loudspeaker apparatus of claim 3,
wherein the loudspeakers are electrically coupled in series.

5. The loudspeaker apparatus of claim 1,
wherein a high cut filter, which restrains an input at high frequencies of at least one terminal-section-side loudspeaker of the loudspeakers, is coupled with the conductive pattern part.

6. The loudspeaker apparatus of claim 2,
wherein the loudspeakers are electrically coupled with one another, and its impedance is equalized or approximated to an impedance of one loudspeaker.

7. The loudspeaker apparatus of claim 2,
wherein a high cut filter, which restrains an input at high frequencies of at least one terminal-section-side loudspeaker of the loudspeakers, is coupled with the conductive pattern part.

8. The loudspeaker apparatus of claim 6,
wherein the loudspeakers are electrically coupled in series.
